(19) United States
(12) Patent Application Publication
(10) Pub. No.: US 2017/0243398 A1
(43) Pub. Date: Aug. 24, 2017

(54) METHOD AND SYSTEM FOR REDUCING VOLUME OF THREE-DIMENSIONAL MODELING DATA

(71) Applicant: GAIA3D INC., Daejeon (KR)

(72) Inventors: Seong Do SON, Daejeon (KR); Seung Yub KIM, Daejeon (KR); Ju Hyeon GIM, Daejeon (KR)

(21) Appl. No.: 15/519,397

(22) PCT Filed: Oct. 14, 2015
(86) PCT No.: PCT/KR2015/010831

§ 371 Date: Apr. 14, 2017

(30) Foreign Application Priority Data
Oct. 15, 2014 (KR) 10-2014-0139222

(51) Int. Cl. G06T 17/20

(52) U.S. Cl. CPC G06T 17/20; G06T 2210/04; G06T 2210/32

(57) ABSTRACT

Disclosed is a method for reducing volume of 3D modeling data, including: a first step of selecting a block object in the 3D modeling data, a second step of extracting from the 3D modeling data a target block to be comparable with the block object, a third step of comparing the block object with the target object, and a fourth step of designating the target object as a reference object if the block object and the target object are turned out to be identical with each other as a result of the comparing step.

### FIELD

The present disclosure relates to a method and system for reducing volume of three-dimensional (3D) modeling data, and more specifically, to a method and system for converting 3D modeling data to lightweight data by reducing storage volume of the 3D modeling data.

### BACKGROUND ART

This section provides background information related to the present disclosure which is not necessarily prior art.

In order to provide efficient web services of 3D modeling data, it is necessary to make storage volume of the 3D modeling data lighter.

3D geometric object data denotes 3D data on a geometric object with a certain form including, for example, a wall in a building, a tree, a chair, etc., which is visible to a user through a display such as a monitor

3D modeling is a process of converting a geometric object into 3D geometric object data.

3D modeling data includes multiple 3D geometric object data. For example, while 3D geometric object data includes 3D visual data on a chair, 3D modeling data may include 3D geometric object data on 10 chairs, respectively. FIG. 1 illustrates an example of 3D geometric object data of a 3D modeling desk being displayed three dimensionally.

The desk in FIG. 1 is shown in a polygon mesh form. As shown in the drawing, it made up of numerous vertices. Each triangle formed by vertices as in FIG. 1 is called a mesh, and a 3D geometric object built by multiple meshes is called a polygon mesh model.

Referring to FIG. 1, a general polygon mesh model only describes shape information for surfaces of a 3D geometric object having interior void spaces. A level of detail (LOD) of a polygon mesh model depends on the size of a triangle forming a mesh. In other words, a higher level of detail is obtained with a larger number of smaller triangles.

Although a specific storage form of a polygon mesh-based 3D geometric object data typically varies according to a given format, three items, i.e. a vertex list, a face list, and a UV list are essential for a polygon mesh. In general, 3D geometric object data is stored in a binary format.

The vertex list supplies 3D coordinates of every point that constitutes a 3D object, together with point IDs, in order. 3D coordinates of such points are called vertex coordinates.

The face list defines each individual triangular face formed by three vertices connected, and consists only of point IDs that are not included in the vertex list.

The UV list designates a position of texture applied to each face in a texture image, in which each position of texture is mapped to a point ID of each vertex of a face. In case of applying texture in a separate file to each face, a file name is directly designated, without necessarily storing the UV list. However, due to an excessive increase in the number of files in that case, one texture file is usually used.

In general, users are able to understand a geometric object better when the object is visualized in 3D, instead of in 2D. It is also known that larger data volumes are needed to visualize 3D geometric objects than 2D geometric objects on a display. Such a large volume of 3D geometric object data has been a limiting factor for providing a web service over the Internet. In particular, a large storage volume of 3D modeling data that include many pieces of 3D geometric object data has been a major limitation on the Internet-based services. There have been a number of studies to find a way to reduce large volume of 3D modeling data, and a typical example thereof is CityGML, which has been implemented to obtain lightweight 3D virtual city model data.

CityGML (City-Geography Markup Language) is an XML-based data model and exchange format to store 3D virtual models of cities, and it is implemented as an application schema for GML (Geography Markup Language). The GML is an ISO (International Standards Organization) 19136—based and developed by the OGC (Open Geospatial Consortium). It is implemented as an application schema, such as, CityGML or 3DF-GML, as exchange formats of meta data. CityGML incorporates the concept of implicit geometry to obtain lightweight 3D virtual city model data. According to the concept of implicit geometry, if there are geometric objects having the same topology, a prototype geometric object for representing those geometric objects having the same topology is created. For example, prototype geometric objects for trees, traffic lights, road signs, etc., which are repeatedly used in a 3D virtual city model, are stored, and a corresponding prototype geometric object is retrieved at a particular position in the global coordinate system using a transformation matrix and base point data so as to display the geometric object at the corresponding position. A geometric object used for retrieving and displaying a prototype geometric object is called a reference geometric object. Therefore, instead of creating a 3D model for every tree, traffic light, road sign, etc., which are repeatedly used, only a prototype geometric object for each group is subjected to 3D modeling, and a reference geometric object is expressed in terms of a transformation matrix and base point data for a corresponding prototype geometric object. That is to say, 3D modeling data in CityGML does not necessarily include every tree, traffic light, road sign, etc., which are repeatedly used, in 3D geometric object data, but it includes prototype geometric object data expressed in the form of 3D geometric object data, and reference geometric object data expressed in the form of transformation matrix and base point data. Here, since the reference geometric object data is not 3D geometric object data resulted from a 3D modeling process, 3D modeling data can be significantly downsized. Those skilled in the art are well familiar with the fact that a transformation matrix and base point data format has a substantially smaller storage volume than a 3D geometric object data format. The transformation matrix and base point data is called coordinate transformation data.

However, there are other occasions where the concept of implicit geometry is not actually applied at the beginning of creating 3D modeling data as in CityGML. For example, BIM (Building Information Modeling) data includes geometric object data partly in a parameter format and partly in a 3D geometric object data (polygon mesh) format. In one approach, today, all geometric object data included in BIM data is converted to 3D geometric object data such that users are able to see the BIM data in 3D. Alternatively, only certain data stored in a parameter format in BIM data is converted to 3D geometric object data. However, once all geometric object data in the BIM data is converted to 3D geometric object data, a huge storage volume is then required for storing 3D modeling data thus obtained. This problem is found not only in the BIM data, but also in the 3D modeling data where a plurality of geometric objects has been converted to 3D geometric object data.

Accordingly, the present disclosure is directed to reduce volume of 3D modeling data on 3D models of a plurality of geometric objects.

### DISCLOSURE

### Technical Problem

The problems to be solved by the present disclosure will be described in the latter part of the best mode for carrying out the invention.

### Technical Solution

This section provides a general summary of the present disclosure and is not a comprehensive disclosure of its full scope or all of its features.

According to one aspect of the present disclosure, there is provided a method for reducing volume of 3D modeling data, including: a first step of selecting a block object in the 3D modeling data; a second step of extracting from the 3D modeling data a target block to be comparable with the block object; a third step of comparing the block object with the target object; and a fourth step of designating the target object as a reference object if the block object and the target object are turned out to be identical with each other as a result of the comparing step.

According to another aspect of the present disclosure, there is provided a 3D modeling data processing system for reducing volume of the 3D modeling data, including: a data receiving part for receiving 3D modeling data whose volume needs to be reduced; a selecting part for extracting a block object and a target object from the 3D modeling data; a primary comparison part for comparing geometric information on the block object and the target object selected; a secondary comparison part for comparing all vertex coordinates of the block object having been transformed through a transformation matrix with all vertex coordinates of the target object; and a storing part for storing the target object as a reference object, once the block object and the target object are turned out to be identical with each other in the secondary comparison part.

### Advantageous Effects

The advantageous effects of the present disclosure will be described in the latter part of the best mode for carrying out the invention.

### BRIEF DESCRIPTION OF DRAWINGS

FIG. 1 illustrates one example of a 3D model of a desk displayed in 3D.

FIG. 2 describes a block/reference concept used in the present disclosure.

FIG. 3 describes step by step how to reduce storage volume of 3D modeling data according to the present disclosure.

FIG. 4 describes an example of comparing mesh shapes.

FIG. 5 describes in detail an example of comparing a block object with a target object.

FIG. 6 describes a 3D modeling data processing system for reducing storage volume of the 3D modeling data.

### BEST MODE FOR CARRYING OUT INVENTION

The present disclosure will now be described in detail with reference to the accompanying drawings.

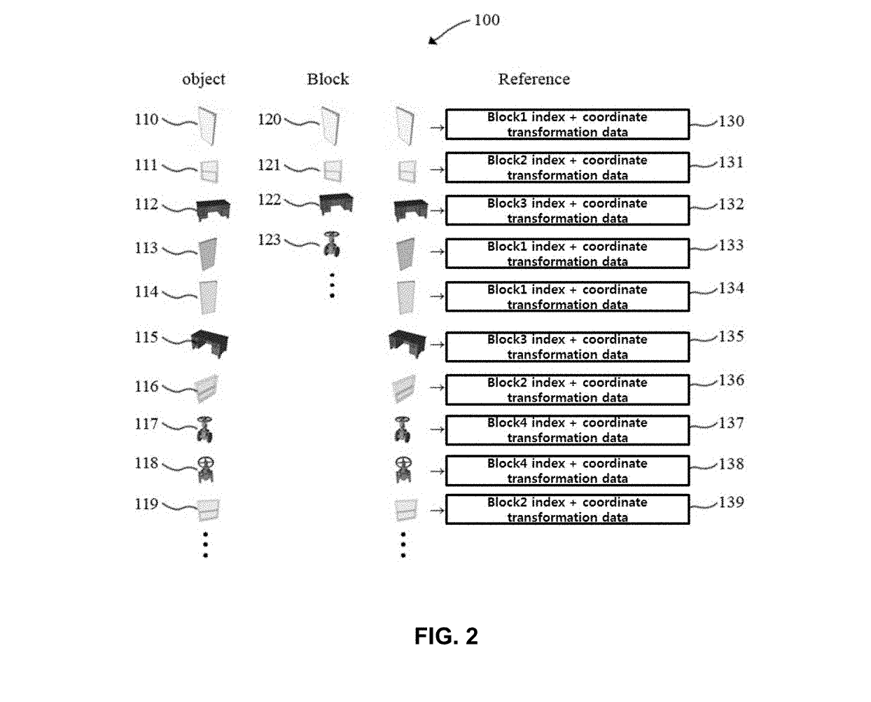

FIG. 2 describes a block/reference concept used in the present disclosure.

In case of BIM data, since every geometric object is artificially created into 3D models, each of the geometric objects does not have its own shape. FIG. 2 shows how to reduce storage volume of 3D modeling data where every geometric object has 3D geometric object data, using the block/reference concept 100. Original 3D modeling data includes 3D geometric object data for a 1st geometric object 110, a 2nd geometric object 111, a 3rd geometric object 112, a 4th geometric object 113, a 5th geometric object 114, a 6th geometric object 115, a 7th geometric object 116, an 8th geometric object 117, a 9th geometric object 118, and a 10th geometric object 119, respectively. The 1st geometric object 110, the 4th geometric object 113, and the 5th geometric object 114 are all duplicate forms of a door. The 2nd geometric object 111, the 7th geometric object 116, and the 10th geometric object 119 are all duplicate forms of a window. The 3rd geometric object 112 and the 6th geometric object 115 are all duplicate forms of a desk. The 8th geometric object 117 and the 9th geometric object 118 are all duplicate forms of a valve. Here, the term ‘duplicate form’ is intended to mean that the geometric objects exhibit the same shape, without necessarily having the same directions and base points. For example, comparing the orientation of the 3rd geometric object 112 with that of the 6th geometric object 115, both representing a desk, the 6th geometric object 115 is leaned towards the left side with respect to the 3rd geometric object 112. Originally, in the 3D modeling process, geometric objects having the same shape but different orientations and base points are regarded as different objects, such that 3D melding is executed on each geometric object and the corresponding 3D geometric object data is stored accordingly, causing an increase in the storage volume of the data. In this disclosure, however, the block/reference concept is introduced to reduce storage volume of the original 3D modeling data. First of all, one of geometric objects having the same shape is chosen as a block object. For example, a 1st block object 120 has 3D geometric object data for the 1st geometric object 110. Next, those geometric objects corresponding to a door, i.e. the 1st geometric object 110, the 4th geometric object 113, the 5th geometric object 114 are designated and saved as a 1st reference object 130, a 4th reference object 133, and a 5th reference object 134, respectively. Here, data on the 1st reference object 130, the 4th reference object 133 and the 5th reference object 134 are not 3D geometric object data for the 1st geometric object 110, the 4th geometric object 113 and the 5th geometric object 114. The 1st reference object 130 only has index data for the 1st block object 120 and coordinate transformation data for the 1st geometric object 110. The 4th reference object 133 only has index data for the 1st block object 120 and coordinate transformation data for the 4th geometric object 113. The 5th reference object 134 only has index data for the 1st block object 120 and coordinate transformation data for the 5th geometric object 114. The index data for the 1stblock object 120 is information indicating that the 1st reference object 130 corresponds to the 1st block object 120. For example, suppose that the 1st block object 120 corresponds to a door, the 2nd block object 121 corresponds to a window, the 3rd block object 122 corresponds to a desk, and the 4th block object 123 corresponds to a valve. With the index data mentioned above, the 1st reference object 130 among other block objects is the one related to the 1st block object 120, which is a door. The coordinate transformation data includes base point data and orientation information on the 1st geometric object 110, the 4th geometric object 113 and the 5th geometric object 114. In case of BIM data, the base point data is locational information indicating where in a building a desk is located. The orientation information is information indicating whether the desk is leaned towards the left side or right side.

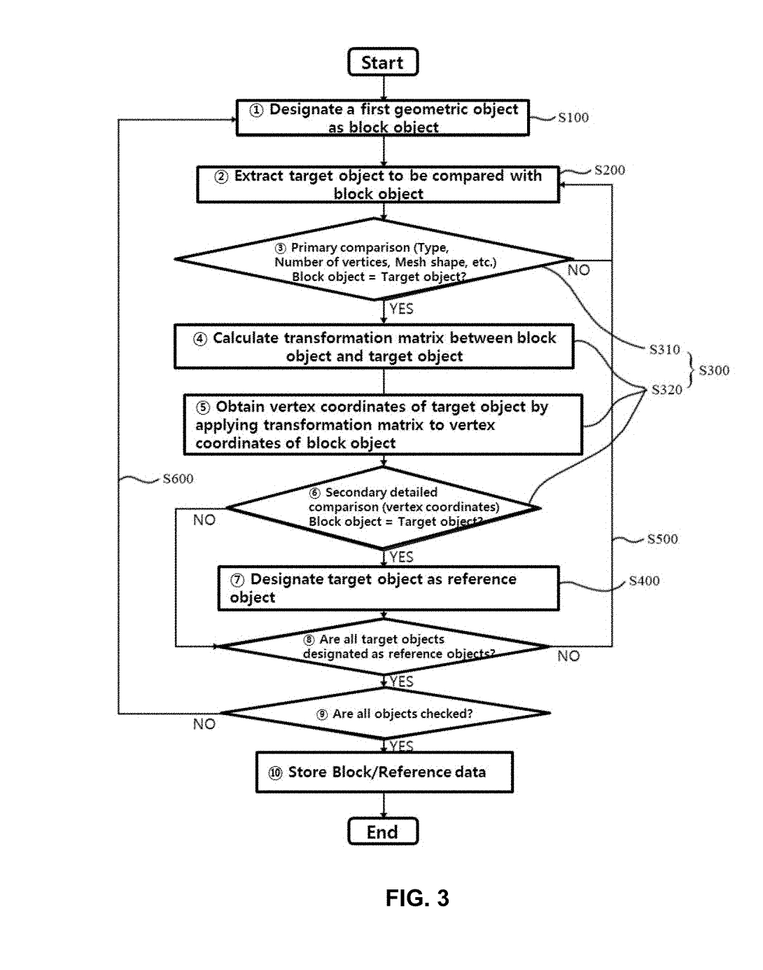

FIG. 3 describes step by step how to reduce storage volume of 3D modeling data according to the present disclosure.

The present disclosure incorporates the concept of block and reference objects to reduce volume of 3D modeling data on 3D models of every geometric data.

Referring to FIG. 3, in S100, a first geometric object, which corresponds to a block object, is selected from a data structure containing geometric information of 3D modeling data.

In S200, a target object is extracted for comparison from the rest of the geometric objects except for the selected block object.

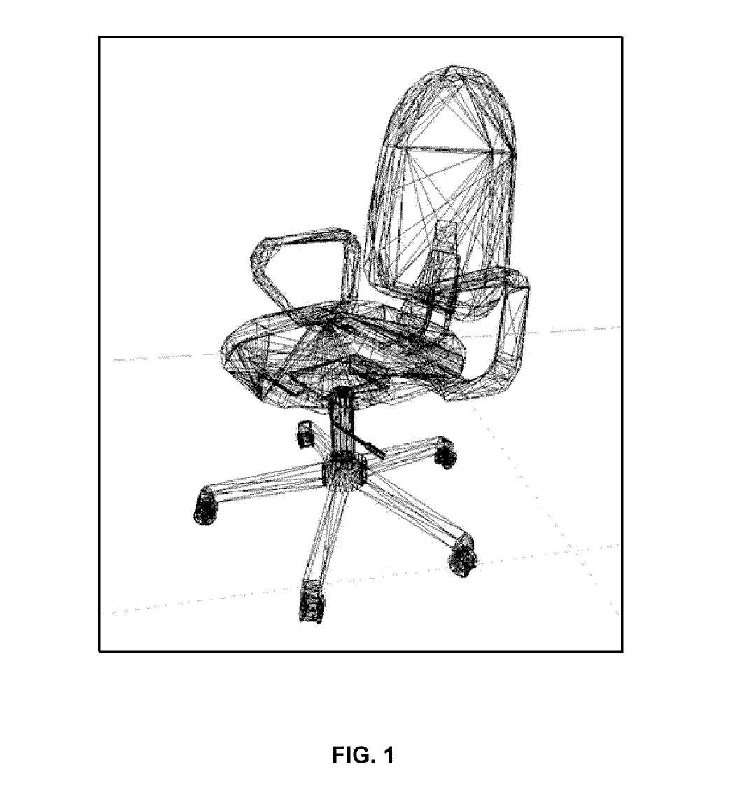

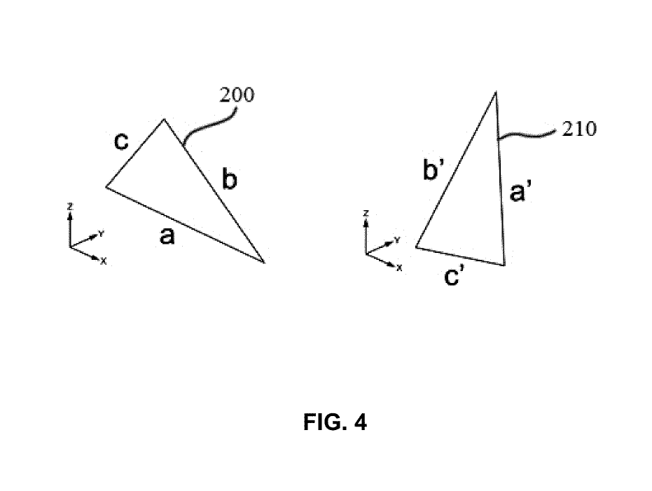

In S300, the selected block object is compared with the target object to determine similarity between them. Here, in S310, similarity between the block object and the target object is determined using geometric information on each of the objects. The geometric information includes the type, number of vertices, mesh shape and so on of each of the block and target objects. For example, in case of BIM data, the type indicates whether an object of interest is a piece of furniture, a wall, a door or the like. The number of vertices refers to the number of vertices of a polygon (e.g., a triangle as in FIG. 1) visualized through a mesh form in 3D modeling data. The mesh shape refers to information on multiple triangles that constitute a respective mesh. In case of a vertex list, this information is stored in order, as discussed previously. Here, the lengths of sides of a first, stored triangle of the block object are compared with the lengths of sides of a first, stored triangle of the target object, and when it turns out that their lengths of sides are same, it is determined that the target object is identical with the block object. This comparison of the lengths of sides of triangles is illustrated in FIG. 4.

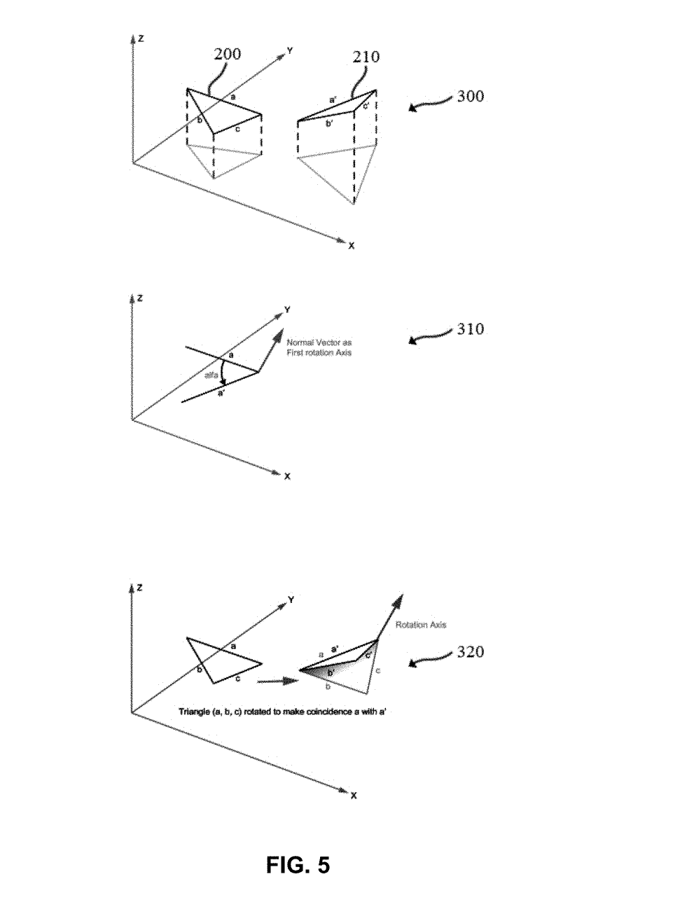

In S320, the block object and the target object, which turned out to be identical with each other in S310, are subjected to a more detailed comparison. This detailed comparison process is shown in FIG. 5.

In S400, the target object that has been determined to be identical with the block object is designated as a reference object. At this time, the reference object does not have 3D geometric object data that the target object has. As explained in reference to FIG. 2, the reference object has index data for the block object and coordinate transformation data for the target object. S200 through S400 are repeated (S500) until all reference objects corresponding to the block object selected in S100 are found. Moreover, when there are multiple block objects, S100 through S400 are repeated (S600). For example, suppose that a chair is retrieved from BIM data and designated as a block object. Then target objects corresponding to chairs are all designated as reference objects. Again, suppose that a door is retrieved from BIM data and designated as a block object. Then target objects corresponding to doors are all designated as reference objects.

When 3D modeling data is BIM data, information on the type of a geometric object is listed in IFC entity type. Therefore, with this IFC entity type information, similarity between the block object and any target object can be determined in a much shorter amount of time.

FIG. 4 describes an example of comparing mesh shapes.

Geometric objects such as a block object and target objects are stored in polygon mesh-type 3D geometric object data, as in FIG. 1. The polygon mesh consists of a plurality of triangles. Information on the plurality of triangles is stored in the vertex list in order. Among these triangles, a first triangle of the block object and a first triangle of the target object are selected, and the lengths of sides of these triangles are compared. Referring to FIG. 4, three sides, a, b and c, of a first triangle 200 of the block object are compared with three sides, a′, b′ and c′, of a first triangle 210 of the target object. If those three sides have the same lengths as their corresponding sides (a=a′, b=b′, c=c′), it is determined that the block object and the target object are identical with each other.

FIG. 5 describes in detail an example of comparing a block object with a target object.

First of all, a transformation matrix is calculated using the triangle 200 of the block object and the triangle 210 of the target object, which are used for comparing mesh shapes in FIG. 4. In other words, a transformation matrix for converting the triangle 200 of the block object into the triangle 210 of the target object in a spatial coordinate system is calculated. Referring to 300, these triangles are placed according to their own spatial coordinates in the spatial coordinate system. Referring next to 310, a translation element and a primary rotation matrix with respect to the identical sides (e.g., a and a′) are determined. Referring now to 320, a secondary rotation matrix with respect to the identical sides is determined. The primary and secondary rotation matrices thus obtained are multiplied, and the translation element is applied thereto to determine an overall transformation matrix.

Vertex coordinates of 3D geometric object data of the block object are transformed using the transformation matrix mentioned above. These transformed vertex coordinates of the block object, which have been obtained using the transformation matrix, are compared with vertex coordinates of 3D geometric object data of the target object. If the converted vertex coordinates of the block object coincide with the vertex coordinates of the target object, it is determined that the block object and the target object are identical with each other.

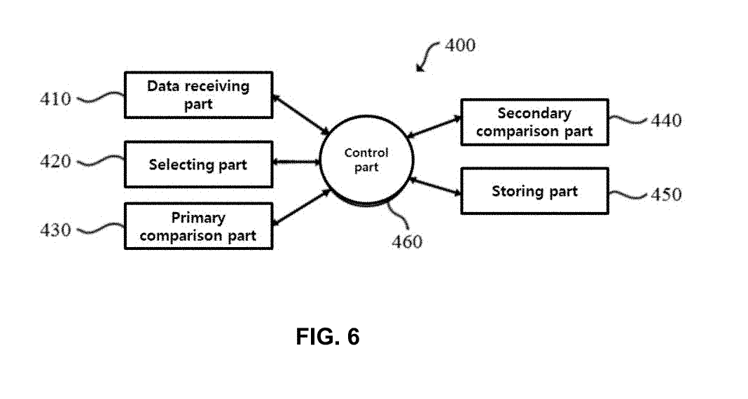

FIG. 6 describes a 3D modeling data processing system for reducing storage volume of the 3D modeling data.

The 3D modeling data processing system 400 according to the present disclosure includes a data receiving part 410 for receiving 3D modeling data whose volume needs to be reduced; a selecting part 420 for extracting a block object and a target object from the 3D modeling data; a primary comparison part 430 for comparing geometric information on the block object and the target object selected; a secondary comparison part 440 for comparing all vertex coordinates of the block object having been transformed through a transformation matrix with all vertex coordinates of the target object; and a storing part 450 for storing the target object as a reference object, once the block object and the target object are turned out to be identical with each other in the secondary comparison part. A control part 460 controls operations of the system 400, in cooperation with each of the components described above.

In particular, the storing part 450 stores 3D geometric object data of a block object, index data on a block object, and coordinate transformation data on a target object. In addition, when 3D modeling data is BIM data, the system may further include a comparison part for comparing IFC entity type of the selected block object with IFC entity type of a target object. This comparison part must execute this IFC entity type comparison operation before the primary comparison part 430 executes its own operation.

The volume of BIM data can be substantially reduced by applying the method of the present disclosure. For example, the size of BIM data having a storage volume of 65.3 MB is increased up to 187 MB if the BIM data is converted to be visible to a user. 61.7 MB out of 187 MB data corresponds to 3D geometric object data for a geometric object. However, by applying the block/reference concept to those duplicate items according to the present disclosure, the volume of the 3D geometric object data was reduced to 4.87 MB. This effect is magnified when 3D modeling data includes a lot of duplicate 3D geometric object data. For example, the effect would be significant if applied to 3D modeling data for 100 buildings, as compared with 3D modeling data for 1 building.

The following will now describe various embodiments of the present disclosure

(1) A method for reducing volume of 3D modeling data includes: a first step of selecting a block object in the 3D modeling data; a second step of extracting from the 3D modeling data a target block to be comparable with the block object; a third step of comparing the block object with the target object; and a fourth step of designating the target object as a reference object if the block object and the target object are turned out to be identical with each other as a result of the comparing step.

(2) The method for reducing volume of 3D modeling data is characterized in that the third step includes the substeps of: (i) executing a primary comparison of the block object and the target object, using geometric information on each of the objects; and (ii) executing a secondary comparison of the block object and the target object, using a transformation matrix.

(3) The method for reducing volume of 3D modeling data is characterized in that the geometric information used for the primary comparison of the block object and the target object is at least one information selected from the number of vertices, mesh shape, and type of each of the block and target objects.

(4) The method for reducing volume of 3D modeling data is characterized in that the comparison of the mesh shape involves comparing the lengths of sides of a triangle that forms a mesh of the block object with the lengths of sides of a triangle that forms a mesh of the target object.

(5) The method for reducing volume of 3D modeling data is characterized in that the transformation matrix used in the substep (ii) is obtained using the triangles that are used for the primary comparison of the block object and the target object.

(6) The method for reducing volume of 3D modeling data is characterized in that the substep (ii) involves transforming all vertex coordinates of the block object using the transformation matrix, and comparing the resulting transformed vertex coordinates of the block object with all vertex coordinates of the target object.

(7) The method for reducing volume of 3D modeling data is characterized in that the second step through the fourth step are repeated until every target object identical with the block object selected in the first step are designated as a reference object.

(8) The method for reducing volume of 3D modeling data is characterized in that, if 3D modeling data has multiple block objects, the first step through the fourth step are repeated until target objects identical with any of the block objects are all designated as reference objects, respectively.

(9) The method for reducing volume of 3D modeling data is characterized in that, if 3D modeling data is BIM (Building Information Modeling) data, the method further includes, between the second step and the third step, a step of comparing IFC entity type of the block object with IFC entity type of the target object.

(10) The method for reducing volume of 3D modeling data is characterized in that, in the fourth step, the reference object has index data for the block object that is identical with the target object, and coordinate transformation data enabling to convert the block object to the target object.

(11) A 3D modeling data processing system for reducing volume of the 3D modeling data, including: a data receiving part for receiving 3D modeling data whose volume needs to be reduced; a selecting part for extracting a block object and a target object from the 3D modeling data; a primary comparison part for comparing geometric information on the block object and the target object selected; a secondary comparison part for comparing all vertex coordinates of the block object having been transformed through a transformation matrix with all vertex coordinates of the target object; and a storing part for storing the target object as a reference object, once the block object and the target object are turned out to be identical with each other in the secondary comparison part.

(12) The 3D modeling data processing system for reducing volume of the 3D modeling data is characterized by further including a comparison part for comparing IFC entity type of the selected block object with IFC entity type of the target object when the 3D modeling data provided to the data receiving part is BIM data, with the comparison part executing said comparing before the first comparison executes its own operation.

Accordingly, the present disclosure can substantially reduce volume of 3D modeling data for 3D models of a plurality of geometric objects.

What is claimed is:

1. A method for reducing volume of 3D modeling data, comprising:
a first step of selecting a block object in the 3D modeling data;
a second step of extracting from the 3D modeling data a target block to be comparable with the block object;
a third step of comparing the block object with the target object; and
a fourth step of designating the target object as a reference object if the block object and the target object are turned out to be identical with each other as a result of the comparing step.

2. The method according to claim 1, wherein the third step comprises: the substeps of:
(i) executing a primary comparison of the block object and the target object, using geometric information on each of the objects; and
(ii) executing a secondary comparison of the block object and the target object, using a transformation matrix.

3. The method according to claim 2, wherein the geometric information used for the primary comparison of the block object and the target object comprises at least one information selected from the number of vertices, mesh shape, and type of each of the block and target objects.

4. The method according to claim 3, wherein the comparison of the mesh shape involves comparing the lengths of sides of a triangle that forms a mesh of the block object with the lengths of sides of a triangle that forms a mesh of the target object.

5. The method according to claim 2, wherein the transformation matrix used in the substep (ii) is obtained using the triangles that are used for the primary comparison of the block object and the target object.

6. The method according to claim 2, wherein the substep (ii) involves transforming all vertex coordinates of the block object using the transformation matrix, and comparing the resulting transformed vertex coordinates of the block object with all vertex coordinates of the target object.

7. The method according to claim 1, wherein the second step through the fourth step are repeated until every target object identical with the block object selected in the first step are designated as a reference object.

8. The method according to claim 1, wherein if 3D modeling data has multiple block objects, the first step through the fourth step are repeated until target objects identical with any of the block objects are all designated as reference objects, respectively.

9. The method according to claim 1, wherein if 3D modeling data is BIM (Building Information Modeling) data, the method further includes, between the second step and the third step, a step of comparing IFC entity type of the block object with IFC entity type of the target object.

10. The method according to claim 1, wherein, in the fourth step, the reference object has index data for the block object that is identical with the target object, and coordinate transformation data enabling to convert the block object to the target object.

11. A 3D modeling data processing system for reducing volume of the 3D modeling data, comprising:
a data receiving part for receiving 3D modeling data whose volume needs to be reduced;
a selecting part for extracting a block object and a target object from the 3D modeling data;
a primary comparison part for comparing geometric information on the block object and the target object selected;
a secondary comparison part for comparing all vertex coordinates of the block object having been transformed through a transformation matrix with all vertex coordinates of the target object; and
a storing part for storing the target object as a reference object, once the block object and the target object are turned out to be identical with each other in the secondary comparison part.

12. The system according to claim 12, further comprising:
a comparison part for comparing IFC entity type of the selected block object with IFC entity type of the target object when the 3D modeling data provided to the data receiving part is BIM data, with the comparison part executing said comparing before the first comparison executes its own operation.
